(19) United States
(12) Patent Application Publication
(10) Pub. No.: US 2013/0048885 A1
(43) Pub. Date: Feb. 28, 2013

(54) LIGHTING MODULE HAVING A COMMON TERMINAL

(71) Applicants: Alejandro V. Basauri, Beaverton, OR (US); Jeff Smith, Hillsboro, OR (US)

(72) Inventors: Alejandro V. Basauri, Beaverton, OR (US); Jeff Smith, Hillsboro, OR (US)

(73) Assignee: Phoseon Technology, Inc., Hillsboro, OR (US)

(21) Appl. No.: 13/223,073

(22) Filed: Aug. 31, 2011

(51) Int. Cl. F21V 29/00; G01J 3/10; F21S 4/00

(52) U.S. Cl. 250/504 R; 362/249.01

(57) ABSTRACT

A lighting module has an electrically conductive heat sink, an array of light-emitting elements mounted on and electrically connected to the conductive heat sink, a flex circuit mounted on the conductive sink, and conductive traces on the flex circuit, the conductive traces connected to the light-emitting elements. A lighting module has a heat sink, an array of light-emitting elements, each element having a cathode terminal and an anode terminal, wherein the heat sink is a common terminal for the elements.

### BACKGROUND

Solid-state light emitters such as light emitting diodes have several advantages over more traditional arc lamps. While these advantages include lower operating temperatures and lower power consumption, performance increases and further costs savings can result from even lower operating temperatures and power consumption.

For example, heat can degrade LED performance in the amount of light output power per square centimeter. Any techniques that allow the LEDs to operate but reduce the heat in the operating environment increases their performance in terms of light output. This also results in longer lifetimes for the individual LEDs, as reducing the heat reduces the wear and tear on the LEDs. Reducing heat generally involves the use of heat sinks and/or cooling systems, either air or liquid.

Reducing power consumption may result in benefits in both lower costs and lowering heat. One of the factors in generating heat involves the amount of power drawn by the devices. If the devices draw less power, they generate less heat in the paths between the emitters and the power supply, as well as keeping the power supply cooler.

Most current techniques reduce temperature and power consumption by adding elements to the light fixture, such as the cooling systems mentioned above, or power controllers, shielding or cladding, etc. Very few techniques address how the devices themselves are configured.

### BRIEF DESCRIPTION OF THE DRAWINGS

FIG. 1 shows a side view of a current LED mounted on a heat sink.

FIG. 2 shows a side view of an embodiment of an LED array having a common anode.

FIG. 3 shows a top view of an embodiment of a flex circuit.

FIG. 4 shows an embodiment of an LED array employing a common anode.

FIG. 5 shows an embodiment of an LED array with a common anode mounted on a heat sink assembly.

FIG. 6 shows a wiring diagram for a prior art LED array.

FIG. 7 shows an embodiment of a wiring diagram for an LED array having a common anode.

### DESCRIPTION OF THE EMBODIMENTS

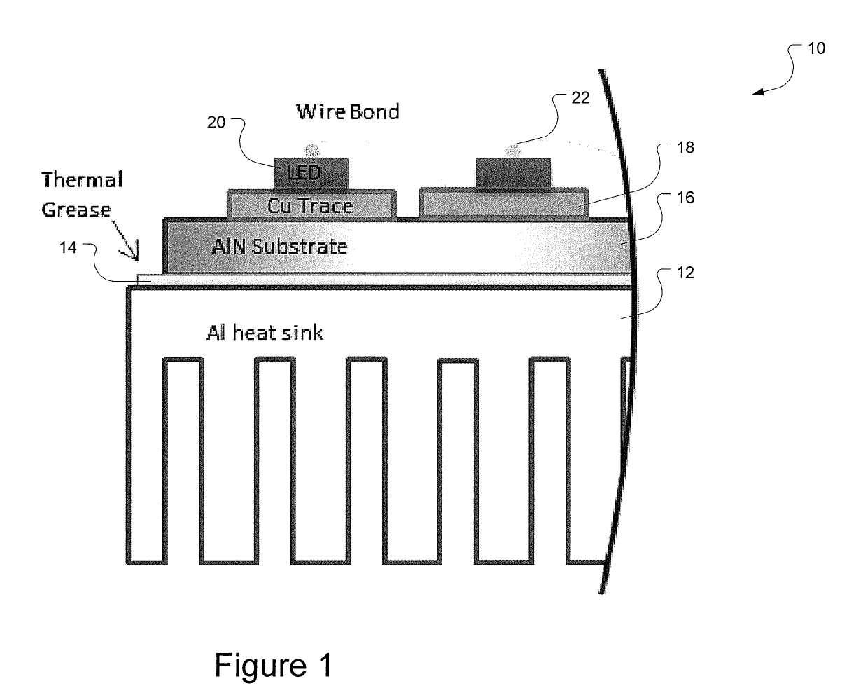

FIG. 1 shows an example of the current implementation of an LED array used in a lighting module. LEDs have many advantages over traditional lamps, especially those used in curing applications. They typically operate at lower temperatures and consume less power. However, solid state devices may suffer from degraded performance when heated. While LEDs operate at lower temperatures, the heat they generate can affect their output power. Many cooling techniques may manage the heat, including the use of heat sinks, typically a piece of thermally conductive material that conducts the excessive heat away from the LEDs.

FIG. 1 shows a current implementation of an LED array 10 mounted to a heat sink 12. LEDs typically have a cathode and an anode. Generally, the anode of each LED 20 resides on a conductive trace 18, with the cathode wired to the adjacent conductive trace 18 by a wire bond such as 22. The conductive trace 18 resides on an intervening substrate. This example has an intervening substrate consisting of aluminum nitride substrate 16. The intervening substrate 16 mounts to the heat sink 12 through thermal grease 14.

Issues arise with this configuration, as heat must pass through the conductive trace, the intervening substrate, and the thermal grease to reach the heat sink, at which point it finally dissipates. This results in a high level of thermal resistance, which has some similarities to electrical resistance, especially in that it takes more power to generate the same irradiance output as heat increases.

In the example of FIG. 1, each anode and cathode for each light-emitting element connects separately. However, one can form the LED arrays to have the light-emitting elements share a common anode. This allows for a configuration of the LEDs and the heat sink to decrease the thermal resistance by removing elements from the thermal path.

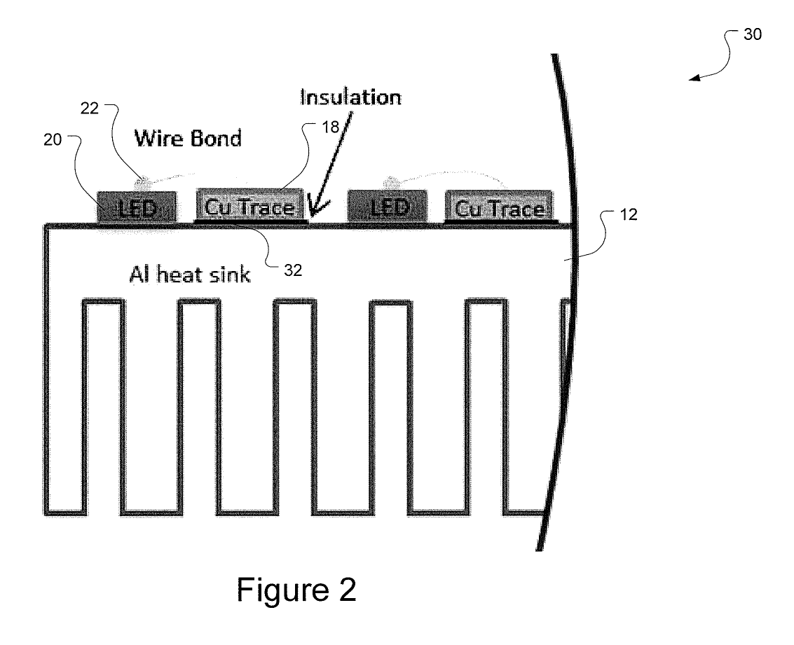

FIG. 2 shows an embodiment of an LED array having a common anode for the light-emitting elements. In the array 30 of the light-emitting elements, the light-emitting elements such as 20 mount directly to the heat sink 12. The heat sink will generally consist of a thermally and electrically conductive heat sink, such as aluminum or copper. The electrical conductivity of the heat sink allows it to provide a common electrical connection to the light-emitting elements' anode. The light-emitting elements may consist of any solid-state elements, such a light-emitting diodes or laser diodes.

The heat sinks may be modular in that they are electrically and thermally isolated, allowing the heat sinks to be tied together or not, depending upon the size of the heat sink. This has the advantage of decreasing the wire gage needed to carry the current to the common anode heat sink connection. This allows products to offer modularity and variable size as an option to capture different markets and uses.

The conductive traces such as 18 cannot reside on the heat sink, as the conductivity of the heat sink will short with the conductive traces. One solution uses an insulator 32 between the heat sink and the conductive traces to which the cathodes of the light-emitting elements connect. In this embodiment, the insulator consists of a flex circuit, which may have at least one layer, typically some type of electrically insulating material like a dielectric. The insulator will have conductive traces residing upon it, such as copper traces. One example of such a layered structure would be a flex circuit.

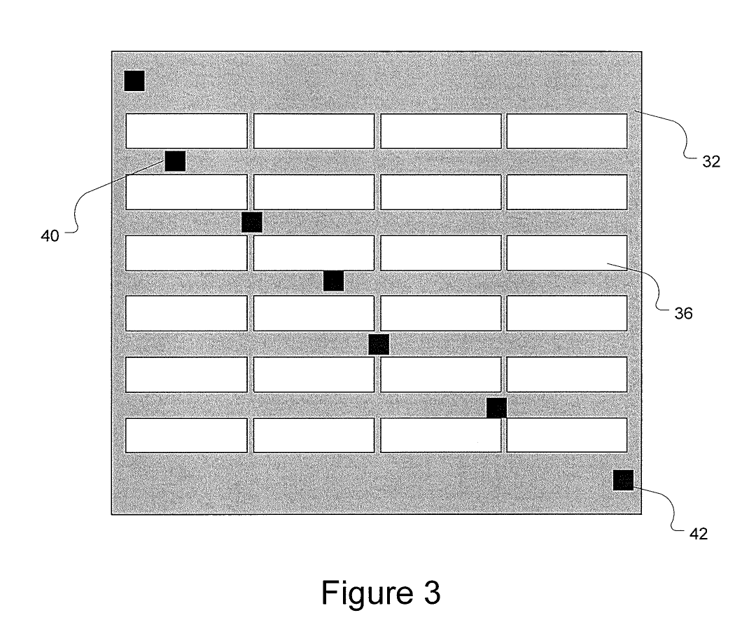

FIG. 3 shows a top view of one embodiment of a flex circuit that can function as insulator 32. The insulator 32 has openings 36 that may accommodate an array of light-emitting diodes. In this particular embodiment, each opening accommodates three light-emitting diodes, but openings may have any configuration needed. In addition, the flex circuit may include photodiodes or transistors such as 40. The flex circuit may also accommodate a thermistor such as 42. These elements allow monitoring of the irradiance output of the LEDs and the heat generated at close proximity to the LEDs.

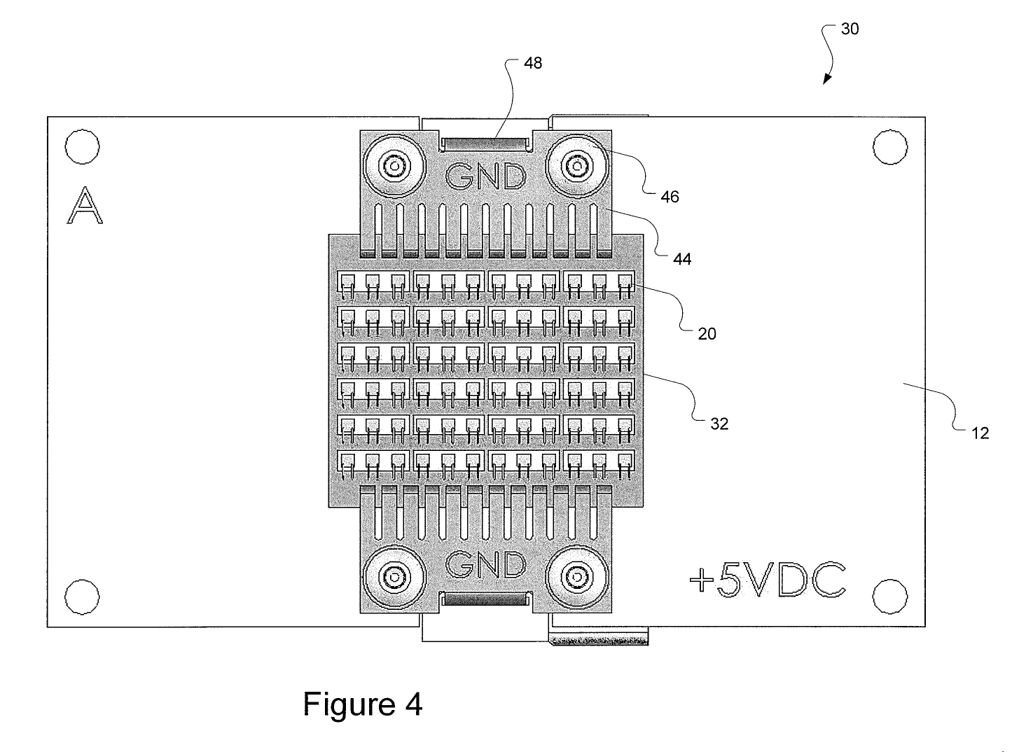

FIG. 4 shows a front view of a lighting module 30. The array of LEDs such as 20 resides on the heat sink 12 with the flex circuit 32. The conductive clip 44 assist in holding the flex circuit 32 to the heat sink. The clips may attach to the heat sink by screws or other attachments such as 46, and provide a return path to ground 48. The screws or other attachments must be electrically isolated from the heat sink to prevent shorting of the Anode and Cathode connections.

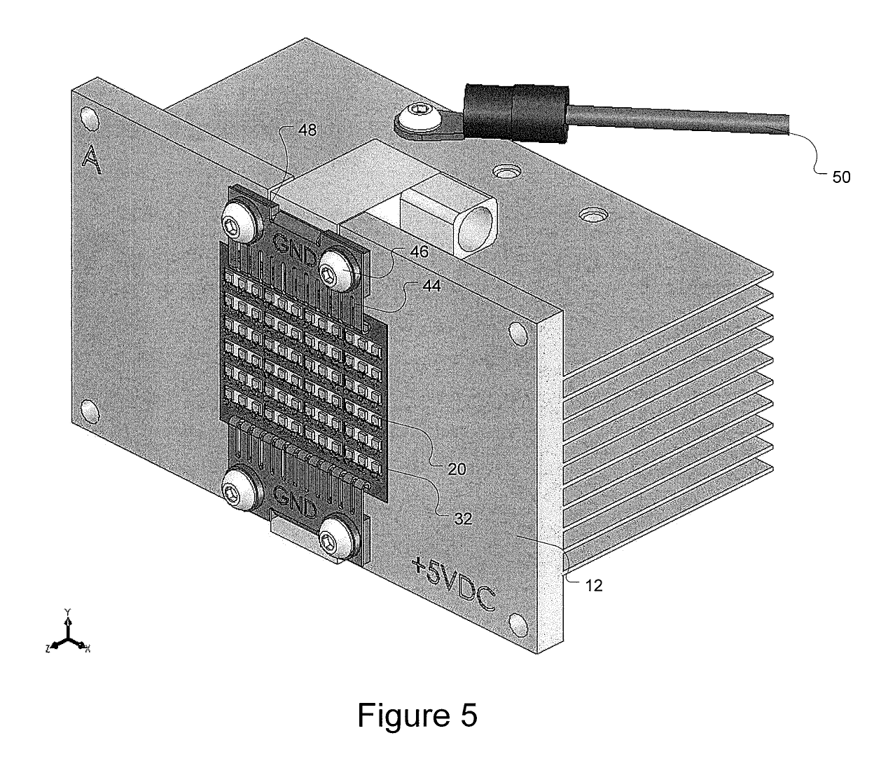

FIG. 5 shows a plan view of the lighting module. The lighting module includes the heat sink 12, the array of LEDs such as 20, the flex circuit 32, the clip 44 and the attachments 48. The heat sink may be attached to a ground path by a ground cable 50 to create the ground path.

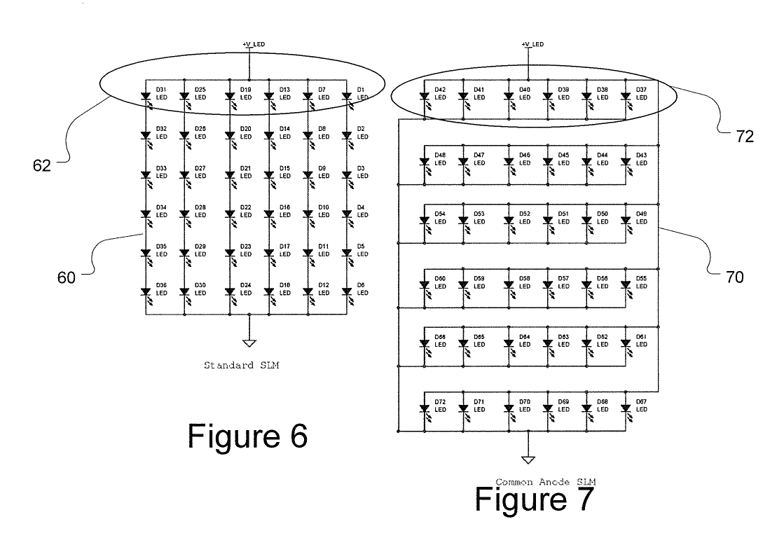

In addition to more efficient heat management by elimination of several of the sources of thermal resistance, the use of a common anode allows different electrical configurations of the array of the light-emitting elements. FIG. 6 shows a wiring diagram for a previous example of an LED array 60. In this wiring diagram, the elements lie in an x-y grid of rows and columns. The designation of rows and columns may be arbitrary, but in this particular example the group of light-emitting elements 62 makes up a row of the array. This row of elements is wired such that each element in a given row is wired in series with the other elements in a particular column.

In contrast, the wiring diagram of FIG. 7 shows one possibility enabled by the common anode configuration. The array 70 has a row 72 in which each element in the row is wired in parallel to the other elements in the array. This may have several advantages. Also, this allows for random placing of the LEDs on the heat sink making it easier to manufacture, construct optical elements to increase light extraction, one could form patterns with the LEDs such as circles or odd shaped polygons to aid in light projection.

While the above discussion focuses on a common anode, one skilled in the art would realize that one could reverse the cathode and anode, change the polarity of the circuitry, and employ instead a common cathode. Therefore, the concept may be referred to as a common terminal.

Although there has been described to this point a particular embodiment for an array of light-emitting elements having a common terminal, it is not intended that such specific references be considered as limitations upon the scope of these embodiments.

What is claimed is:

1. A lighting module, comprising:
a heat sink; and
an array of light-emitting elements, each element having a cathode terminal and an anode terminal, wherein the heat sink is a common terminal for the elements.

2. The lighting module of claim 1, further comprising copper traces mounted on the heat sink such that the copper traces are electrically insulated from the heat sink.

3. The lighting module of claim 2, further comprising an electrical connection between the copper traces and the cathodes of the light-emitting elements.

4. The lighting module of claim 2, wherein the copper traces are electrically insulated from the heat sink by a flex circuit.

5. The lighting module of claim 4, the lighting module further comprising conductive clips arranged to hold the flex circuit to the heat sink.

6. The lighting module of claim 5, wherein the clips are arranged to provide an electrical path to ground.

7. The lighting module of claim 1, wherein the array of light-emitting elements has rows and columns and each element in one row is electrically connected in parallel to the other elements in the same row.

8. A lighting module, comprising:
an electrically conductive heat sink;
an array of light-emitting elements mounted on and electrically connected to the conductive heat sink;
a flex circuit mounted on the conductive sink; and
conductive traces on the flex circuit, the conductive traces connected to the light-emitting elements.

9. The lighting module of claim 8, wherein the conductive heat sink is one of copper or aluminum.

10. The lighting module of claim 8, wherein the array of light-emitting elements comprises an array of light-emitting diodes (LED) that emit ultraviolet light.

11. The lighting module of claim 8, wherein the flex circuit has multiple layers, at least one of which is a dielectric.

12. The lighting module of claim 8, wherein the flex circuit has openings to accommodate the array of light emitting elements.

13. The lighting module of claim 8, wherein the array of light-emitting elements are electrically connected to the heat sink as a common terminal.

14. The lighting module of claim 8, wherein the lighting module further comprises multiple heat sinks, each electrically and thermally isolated unless connected together.
